(19) United States
(12) Patent Application Publication
(10) Pub. No.: US 2005/0167973 A1
(43) Pub. Date: Aug. 4, 2005

(54) Business form intermediate suitable for document carriage or portage through processing

(76) Inventor: Jesse D. Crum, St. Fort Scott, KS (US)

Correspondence Address: WARD KRAFT, INC., P.O. BOX 938, FORT SCOTT, KS, 66701, US

(21) Appl. No.: 10/769,828

(22) Filed: Feb. 2, 2004

(51) Int. Cl. B42D 15/00

(52) U.S. Cl. 283/62

(57) ABSTRACT

The present invention relates to a laminated business form intermediate that is used in the carriage or portage of a business form through processing equipment such that the business form intermediate can be read or scanned and the transaction completed. The intermediate includes a pressure sensitive laminated assembly that uses a pressure sensitive adhesive and release surface so as to be able to expose at least a portion of the adhesive to enable the business form to be connected to the laminate for processing. The business form intermediate of the present invention can accommodate one or more business form documents as well as documents of varying sizes and configurations.

### CROSS-REFERENCES TO RELATED APPLICATIONS

None.

### FIELD OF THE INVENTION

The present invention relates to the field of document carriers or business forms portage devices that are utilized in the processing or handling of documents that may not otherwise be capable of independent processing through reading, printing or sorting equipment or which may facilitate the more efficient scanning, printing or completing the action or transaction related to the document. More particularly, the document carrier of the present invention utilizes a separable or peelable laminated construction that permits the ready use and reuse of the form intermediate as a document carrier, handling tool or portage device.

### BACKGROUND OF THE INVENTION

The marketing of various products and services in today's retail and wholesale environments has created an upsurge in the use of redemption certificates, coupons, rebate checks, and the like. Often such articles range in a variety of sizes due to the delivery mechanism that was used in providing the article to the intended consumer or recipient. In addition, with the rise in business products for home use, the ability to prepare business forms such as checks, coupons and other non-standard configuration forms and the like on an individual basis increases demand for such products and spurs usage by consumers. However, there are difficulties in handling and processing such articles as to do so may require supplement software or additional formatting of printing or processing equipment.

In addition to such business products, other negotiable instruments may need to be treated or handled separately from those received in the normal course of business. Such special handling may arise out of the document having been partially torn or ripped during its processing, loss of MICR numbers which aid in the routing and payment and satisfaction of the sums referenced in the negotiable instrument and other difficulties with the processing of checks, bank drafts and other documents.

One such prior art solution for handling documents is marketed under the trademark LASER TAXI® by Hico Products or Barrington, Ill. and covered by U.S. Pat. No. 5,087,238. This product uses one or more strips of tape to which documents are attached and then a flap is folded over the document while the document is processed through sorting equipment. One of the incumbent difficulties associated with this particular product is that the adhesive contained on the tape has a tendency to loose its adhesive tack strength relatively quickly. In addition, in order to be able to reuse the device, the user must locate the release strip that originally covered the adhesive strips and then carefully reposition the strip over the adhesive tape. This can be a frustrating exercise in that it requires some care in aligning the strip(s) with the adhesvie in order that the form can be saved and reused later. In the event that the release strip is lost or misplaced, then the form likely becomes unusable as it will adhere to any surface that the form comes into contact with and creates a nuisance in the office environment in that the form cannot simply be placed in areas with other papers as the form with its exposed adhesive will stick to the other papers which may potentially cause such papers to be torn upon the attempted removal of the carrier form.

Other prior art solutions include the addition of a label that is attached to check or other document to be processed. While this increases the surface area of the document that is to be handled, it requires the user to find the labels and where the label covers the machine readable indicia, the label must first be printed with the information that is now concealed by the auxiliary label. In addition, the use of such supplemental labels may cause the business form or other document to splay out of alignment with the printing, reading or processing device which can cause improper reads, rendering of incorrect fields and other problems.

Still other prior art solutions include U.S. Pat. No. 6,090,470 which provides for a sheet of paper having an exposed adhesive grid pattern to temporarily hold odd sized documents for scanning. As suggested earlier, with the exposed adhesive pattern, the adhesive may inadvertently stick or adhere to areas or documents that were not intended.

U.S. Pat. No. 5,725,254 utilizes a tab system to hold documents of non-standard configurations in position so that the document may be read by a facsimile machine. The user is then forced to move the tabs into an alternating arrangement so that the form is held in position.

What is needed therefore is a carrier form assembly that is convenient to use and prepare for reuse without suffering from the foregoing drawbacks.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a business form that is provided in an intermediate state and requires further manipulation prior to using the construction for its intended purposes. The business form intermediate is used for the carrying or portage of a business form through processing, handling, printing, sorting, scanning, reading or other equipment that is normally required in order to complete the transaction or action contemplated by the submitter of the business form.

The construction of the present invention includes a peelable or separable laminated arrangement that enables the easy placement and removal of the business form so that the business form can be processed by the user or recipient. Through the use of a release surface and adhesive that enables, the construction of the present invention tk be used in repeated applications.

In one exemplary embodiment of the present invention a business form intermediate suitable for carriage or portage of documents through processing equipment is described and includes a laminate that is constructed from a first sheet that has a front face and a back face. The first sheet has first and second transversely extending end edges and first and second longitudinally extending side edges. In addition, the first sheet has a release surface that is provided on at least a portion of the second face of the sheet of the construction.

In the presently described embodiment, the laminate includes a second sheet that has a front face and a back face. The first sheet has first and second transversely extending end edges and first and second longitudinally extending side edges. The first face has a coating of adhesive that is applied to at least a portion of the first face.

Still referring to this initial embodiment, the first sheet is juxtaposed in substantial alignment with the second sheet such that the release surface is disposed over the coating of adhesive to create a peelable or separable portion of the laminate. In order to facilitate the peeling apart of the laminate, one of the transversely extending end edges of the first sheet, extends beyond one of the transversely extending end edges of the second sheet to create a graspable tab.

The release surface of the present invention may be created through the use of various coatings such as silicone, varnishes or glossy materials, or the release surface can be provided through machine finishing of paper or other substrates. Where coatings of release material are provided, the coatings can be provided in first and second parts or areas so that the release properties are varied thereby creating areas that will release easily and other areas in which the release is more difficult. That is, greater peel force is necessary to achieve separation. Alternatively, where machine finishing is used to create a polished appearance or sheen on the surface of the paper, the adhesive that is used may be varied in tack, ranging from a fully repostionable to more aggressive product that prevents the entire intermediate from being easily separated into individual sheets once the laminate has been formed.

In a further exemplary embodiment of the present invention, a combination business form carrier and business form is provided and includes a business form carrier, taking the form of a laminate that has been produced from first and second sheets that are substantially juxtaposed on one another. The first and second sheets are separable from one another through use of a release surface and an adhesive coating. Each of the first and second sheets has an area, size or dimension.

The combination embodiment also includes a business form that has a size which is less than each of the areas of the first and second sheets of the business form carrier. The business form has first and second faces and the business form is connected to a portion of the laminate on one of the first and second faces through the adhesive.

In use of this embodiment, the business form is contained substantially entirely within the area of one of the first and second sheets of the laminate and is attached to the carrier and then processed through at least one of printing, sorting, reading, scanning equipment.

In yet a still further embodiment of the present invention a method of using a business form carrier is described and includes the steps of initially providing a peelable or separable laminate. The laminate includes first and second sheets that are substantially juxtaposed on one another and at least partially adhered to one another through a release surface and adhesive coating. Next, a portion of the laminate is revealed so as to expose an area of the adhesive coating by peeling back one of the first and second sheets such that the sheets are no longer in complete adhesive engagement with one another. At least one business form is supplied for scanning, printing, sorting, reading, handling or processing. Then, the business form is affixed to the exposed portion of the laminate so that the business form is substantially entirely contained on the exposed portion. Then, the business form on the laminate is fed through at least one of a scanning, printing, sorting, reading, handling or processing equipment.

The presently described method embodiment of the present invention also includes the possible further steps of removing the business form from the exposed portion of the laminate after the step of feeding the business form so that the intermediate or carrier can be reused at a later time.

In a further exemplary step of the present method of use embodiment, the exposed portion of the laminate is concealed by placing a portion of one of the first and second sheets back into adhesive engagement after the step of removing the business form.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross sectional view of the laminate used in constructing the business form intermediate carrier of the present invention;

FIG. 1A provides a front view of the laminate used as a carrier in the present invention;

FIG. 1B represents a side view of the carrier of the present invention and illustrating the graspable tab;

FIG. 2 shows a front view of the business form carrier of the present invention with the first sheet being partially peeled away from the substantially juxtaposed relationship of the laminate;

FIG. 3 illustrates a front view of the business form carrier of the present invention in which a portion of the front sheet has been peeled away from a first portion of the first sheet and folded about a first fold line to fully expose an adhesive area and a business form for affixing to the carrier;

FIG. 4 provides a front view of the combination of the carrier of the present invention along with the business form in position over the exposed area of adhesive;

FIG. 5 depicts an alternate arrangement in which the business form carrier of the present invention is used to support a pair of business forms in the exposed areas of the carrier; and

FIG. 6 shows a block diagram of the present invention providing an exemplary method of using the business form carrier of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

As used herein, the term “business form” is used to refer to checks, coupons, tickets, passes, certificates and any other document that is intended to undergo processing so as to complete a transaction. Such business forms may typically be provided with machine readable indicia which may include bar codes, MICR numbering, alpha and numeric codes and patterns and combinations thereof.

The term “intermediate” is used to describe an assembly that undergoes one or more processing steps prior to being used for its intended purposes. An exemplary treatment or processing step would include the separation or peeling of the laminate to expose adhesive so that the business form may be applied to the carrier intermediate and processed for equipment.

The “equipment” that is contemplated for use with the present invention and combination includes but is not limited to sorting, printing, processing, handling, scanning, reading and combinations thereof.

Unexpectedly, it has been found that a relatively inexpensive and easy to use construction can be fabricated through the use of a pair of substantially equally sized sheets of material. The sheets of the present invention generally have a size of about 8½″ by 11″ but other configurations are of course within the scope of this invention. The sheet material may generally be cellulosic stock, such a bond paper or may be synthetic films (e.g. polyester based materials) or metalized films (e.g. aluminum foils). Through the use of a relatively standard size or configuration, the carrier of the present invention can be used to process documents through a printer or other processing equipment. In this relatively standard sized configuration, the carrier assembly can by used in small home and small office environments (“SOHO”) to process products that would otherwise require additional formatting or software in order to process the communication piece, such as a check. The present invention overcomes the need for such additional software and enables the ready production of odd sized materials.

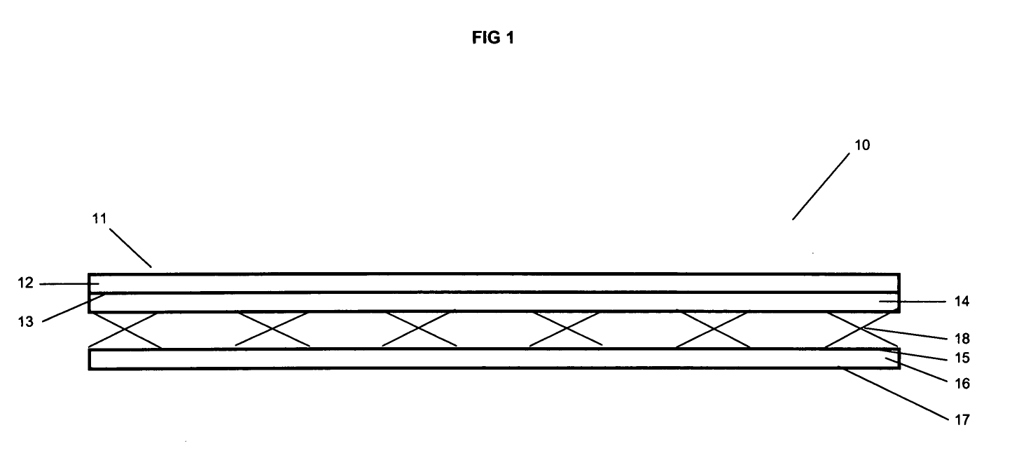

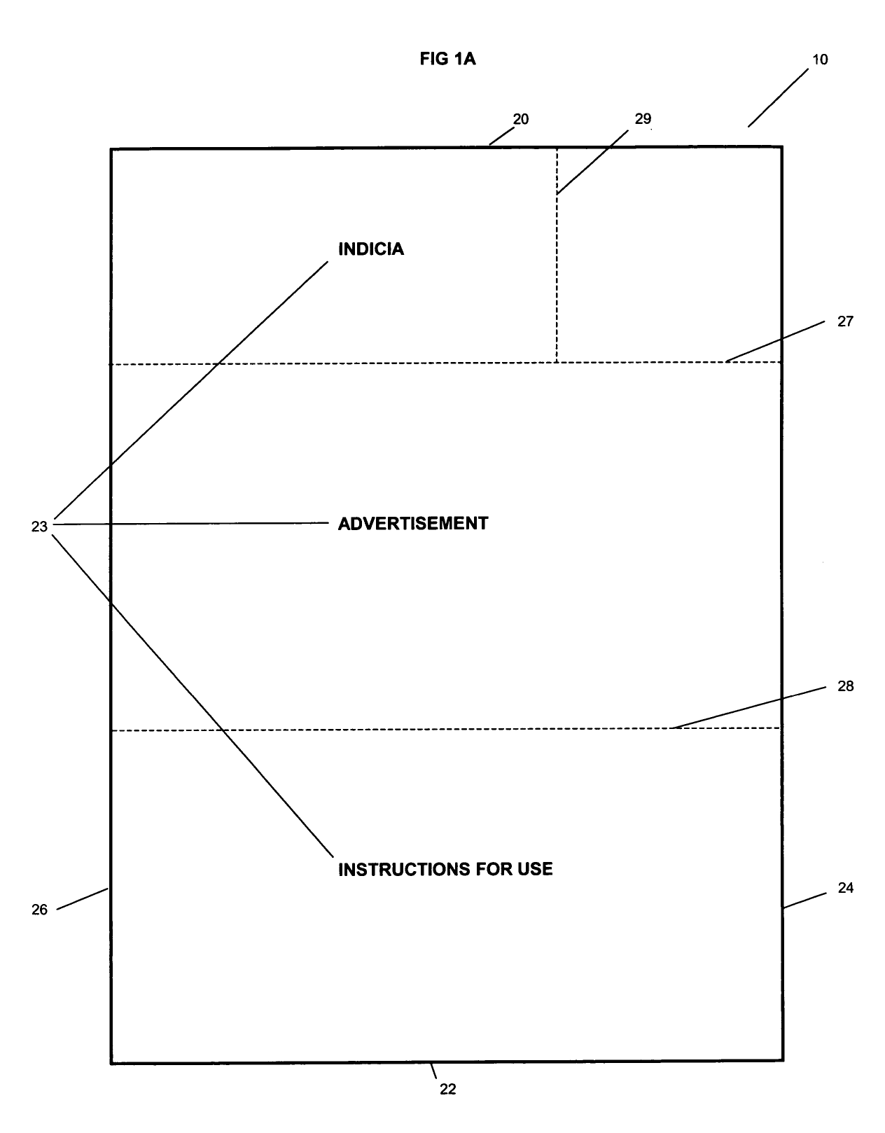

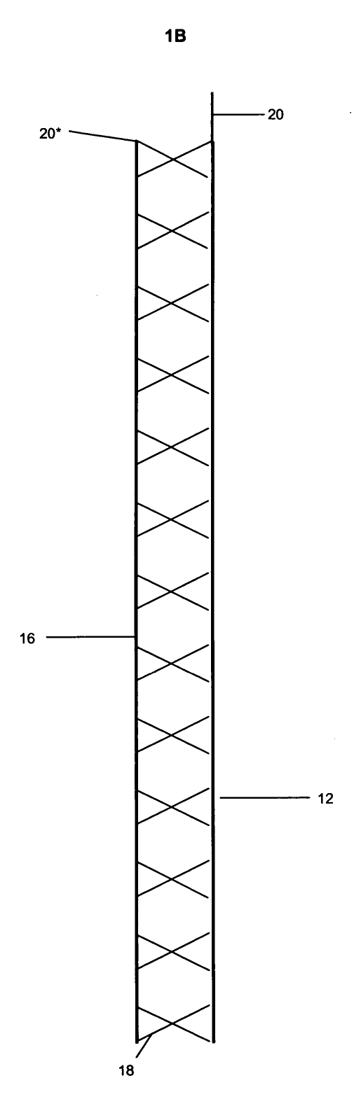

Turning now to FIG. 1, a side view of the laminate used in the creation of the carrier of the present invention is depicted and generally designated by reference numeral 10. The laminate 10 has a first sheet 12 that has first and second faces 11 and 13. The first sheet 12 is provided with a release surface 14.

In one embodiment, the release surface 14 can be created through machine finishing and an exemplary machined finished stock includes 400MF available from Wassau Paper of Wassua, Wis. Machine finished stock is a highly calendared surface that creates a smooth or polished finish or a finish having something of a sheen or glossy appearance.

Alternatively, the release surface 14 suitable for use in the present invention may be created through the application of a coating such as silicone, varnish, wax or the like capable of imparting a slick or smooth surface to the first sheet 12 by such means as are readily understood in the industry.

Where machine finished stock is used in construction of the invention, the first face 11 would be referred to as the “wire” side and the second face 13 is referred to as the “felt” side. The reference to sides are relevant to each of the first and second sheets 12 and 16 used in the manufacture of the laminate 10 of the present invention.

The laminate, carrier or intermediate 10 of the present invention includes a second sheet 16 which again may either be a machined finished stock in which the first face 15 would be the wire side and the second face 17 would be the felt side. The first face 15 of the second sheet 16 is provided with a coating of adhesive 18. The second sheet 16 may also be standard bond paper or other uncoated stock or substrates.

The adhesive may be any suitable type or types of adhesive such as repositionable, removable, permanent and the like and combinations thereof. The adhesive 18 may be pattern coated (selected areas of the sheet) over the first face 15 of the second sheet 16 or may include different types of adhesive or the face 15 may be fully coated with adhesive. That is, where different types of adhesive or patterns are applied, a removable or repostionable, for example, may be coated in a first area and a permanent adhesive in a second area. In this way, a peelable or separable portion as will be discussed is created and the remainder of the assembly is permanently secured together.

In an alternate embodiment, the release surface can be varied such that the sheets 12 and 16 will release more readily from one another in a first part than in a second part. Where a coating is used to create the release surface, the coating can be diminished on the second part so that the repositionable or removable adhesive does not separate as easily from the construction.

The adhesive 18 on the second sheet 16 first face 15 releasably adheres to the release surface 14 of the first sheet 12 second face 13.

Reference is now directed to FIG. 1A which provides a front view of the laminate or carrier 10 of the present invention. In this illustration, the first sheet 12 is depicted and shows the first and second transversely extending end edges 20 and 22 and the first and second longitudinally extending side edges 24 and 26, respectively. In addition, first and second fold lines 27 and 28 are also shown. It should be understood that while FIG. 1A shows the front face of first sheet, the second sheet also has first and second transversely extending end edges and first and second longitudinally extending sides. The fold lines 27 and 28 may run parallel to one another or may be perpendicular to one another so as to be able to accommodate various sized documents or business forms. In addition, multiple fold lines, such as perpendicular line 29 could be provided. The placement of the fold lines 27, 28 and 29 may be predetermined to receive standard sized documents such as a check, business card or the like. More than one fold line may be used in the processing of any particular document or business form. It should be understood that the fold lines are provided for reference only and the user may reveal as much or as little of the adhesive as is necessary to affix a document to the supporting sheet.

The sheets 12 and 16 (FIG. 1) to form the laminate 10 and are placed or juxtaposed substantially on one another. That is, the longitudinally extending side edges are generally in alignment with one another and at least one of the transversely extending end edge are also generally in alignment. Indicia 23 are provided on the face of first sheet 12 (see FIG. 1A). The indicia may include instructions for use, advertising and marketing messages, logos and trademarks of the end user and other indicia that may be relevant to the user or manufacturer of the carrier assembly 10. Indicia for use could include nomenclature such as “fold line for one check”, “fold line for two checks”, “fold line for store coupon” and the like.

FIG. 1B provides a side view of the laminate 10 of the present invention illustrating the first and second sheets 12 and 16 adhered to one another via adhesive 18 and showing the transversely extending end edge 20 and 20* of the sheets in a staggered arrangement such that the edge 20 of the first sheet 12 extends beyond edge 20* of sheet 16 in the longitudinal direction so as to create a graspable portion that will facilitate the separation of the first and second sheets 12 and 16 from one another.

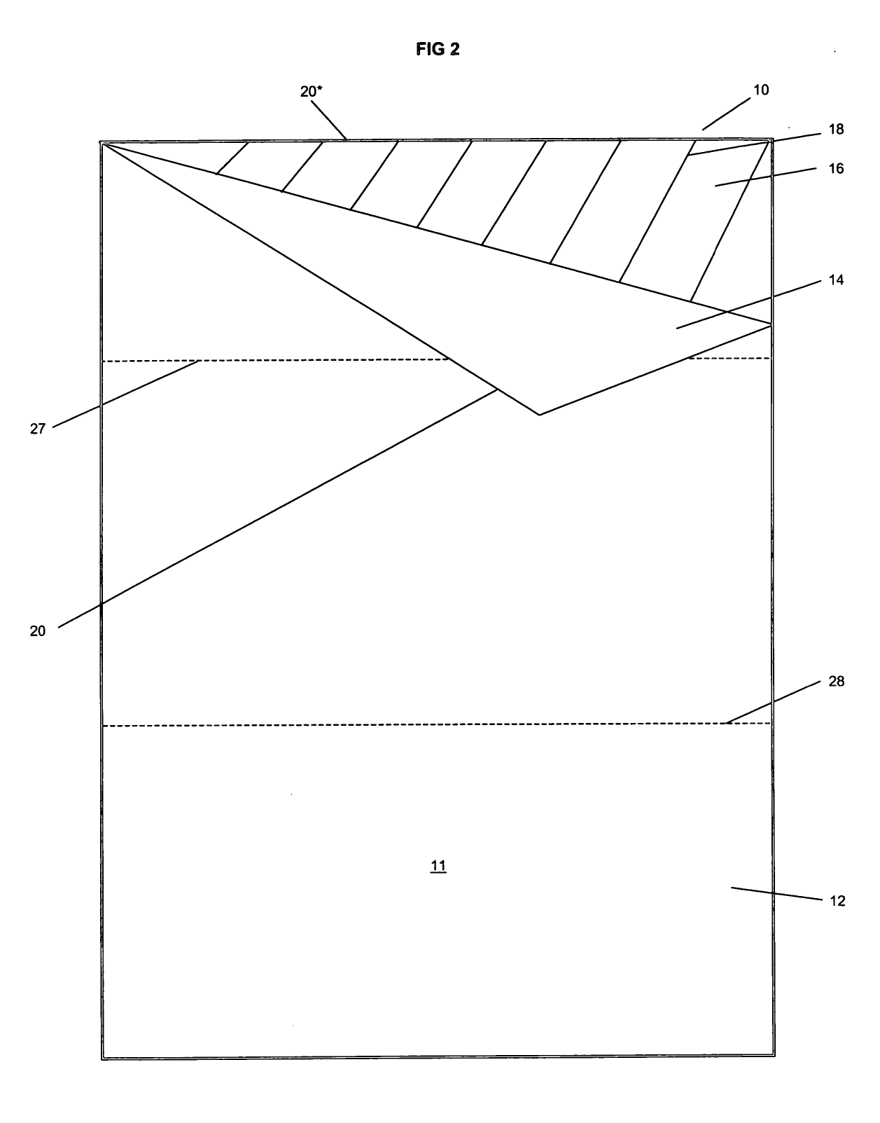

FIGS. 2 through 4 illustrate use of the carrier assembly 10 of the present invention. As shown in FIG. 2, the first sheet 12 is partly pulled away from the second sheet 16 by grasping the first sheet 12 along the transversely extending end edge 20 and pulling the sheet 12 off of the second sheet 16 by the release surface 14. Peeling the first sheet 12 away begins to expose the adhesive 18 that has been applied to the second sheet 16. In an alternate configuration an uncoated adhesive area could be provided along the transverse end edges such that the two sheets could be separated.

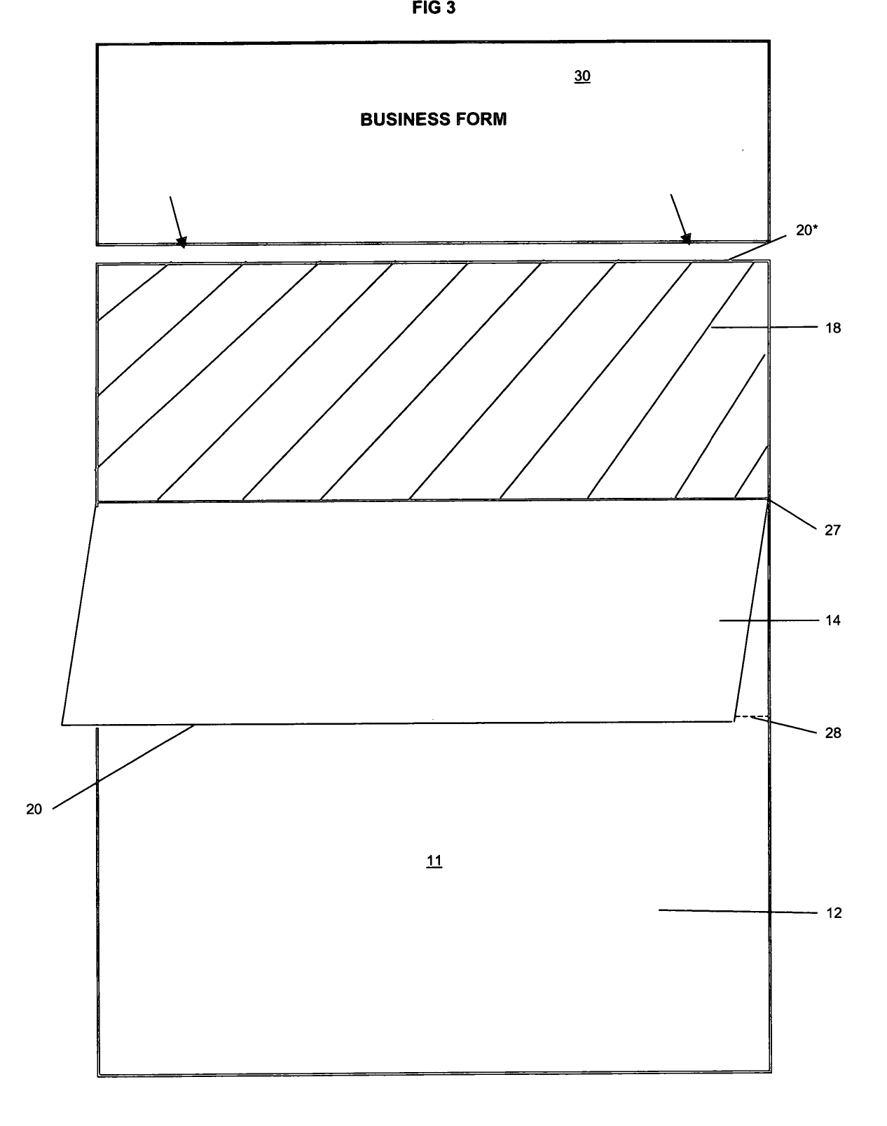

FIG. 3 provides that the first sheet 12 has been pulled to the first fold line 27 (shown in FIG. 2) and a sufficient area of the adhesive 18 coated on the second sheet 16 has been exposed so that a business form 30 can be positioned within the area of the exposed adhesive 18. The fold lines 27 and 28, when utilized, can be a line of weakness, such as a score line, perforation line or the line may simply be printed with indicia on the face 11 of the first sheet 12 to illustrate the area where the first sheet 12 is to be folded or to create a line of demarcation to guide the user. The position of the fold lines 27 and 28 may be predetermined to accommodate the size of the document that the carrier assembly 10 is to accommodate. For example, where the assembly 10 is to be used to carrier checks the fold line will be spaced down the front face an amount equal to the width of the check to be handled. Likewise, for coupons and other business forms lines of demarcation or fold lines can be provided to illustrate the area to be exposed to properly hold those documents.

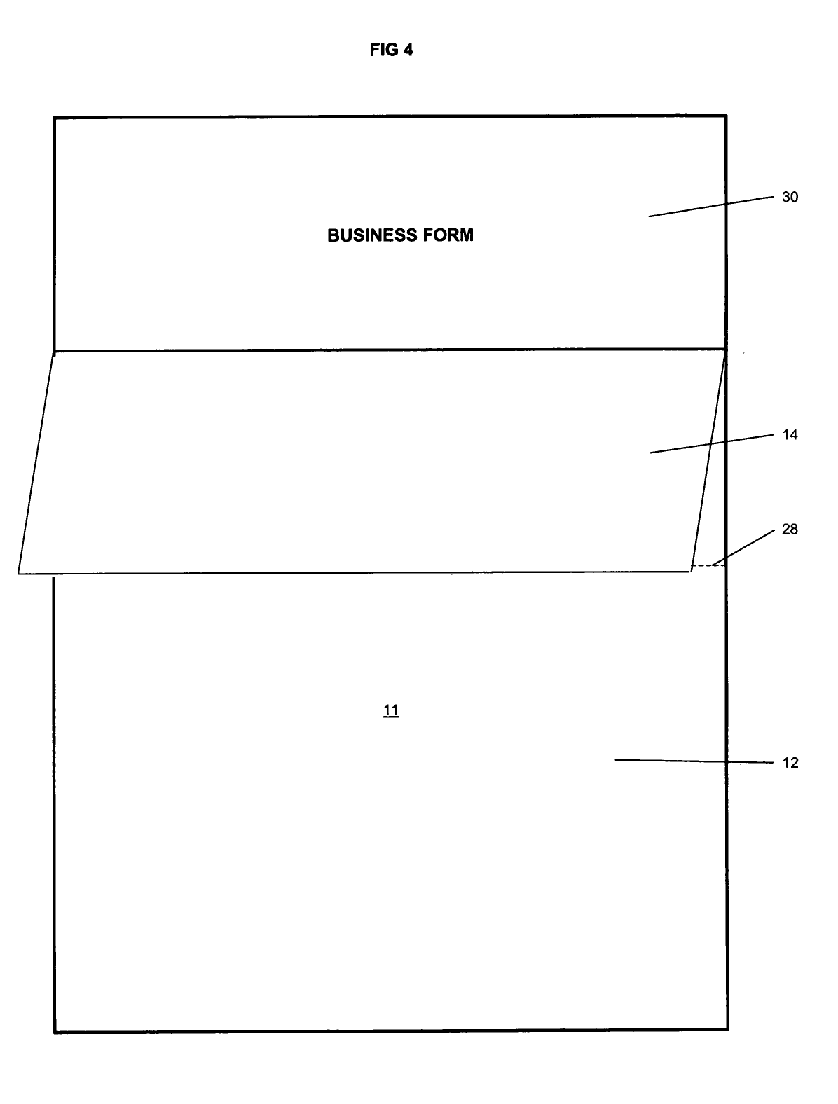

FIG. 4 shows the business form 30 contained substantially entirely within the area of the exposed adhesive 18 on the second sheet 16 (see FIG. 3). In this configuration, the business form 30 may now be processed through a desktop printer or the like without interference with the equipment. That is, the amount of adhesive 18 which is exposed is sufficient to receive and hold the business form but little or no other adhesive is exposed so that no adhesive will come into contact with the apparatus of the printer. The exposed area should be sufficiently large so as to encompass the entire area or size of the business form to be carried by the assembly.

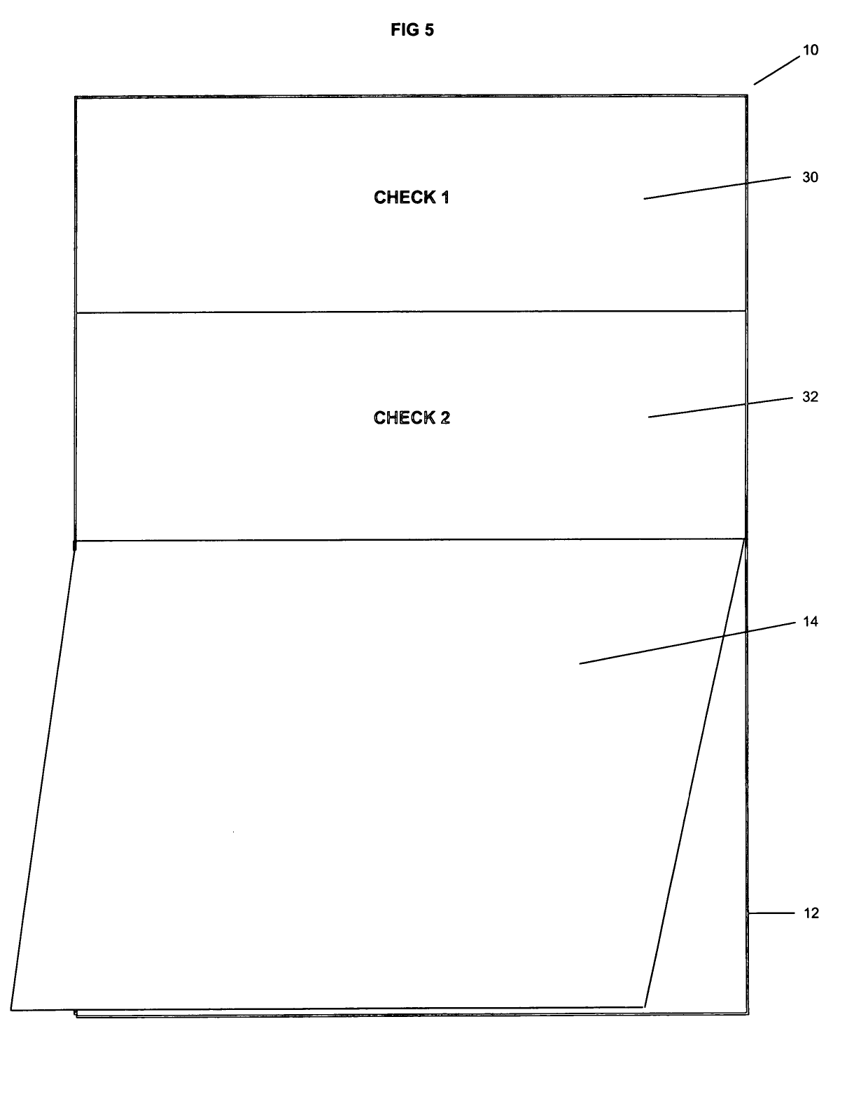

FIG. 5 shows an alternate embodiment of the present invention and includes the use of the laminate 10 to carry plural business forms 30 and 32. In this embodiment, the business forms 30 and 32 are checks to be printed or processed through use of the carrier 10. In each of the embodiments, the first sheet 12 when folded about fold lines 27 and 28 (see FIG. 2 for reference) is generally folded substantially flat so as to not interfere with the processing of the carrier 10 and the business forms 30 and 32 that have been attached to the assembly.

The combination of the business form 30 and 32 and the carrier 10 enables the ready processing of supplemental documents through various types of processing equipment without the imposition of additional labels.

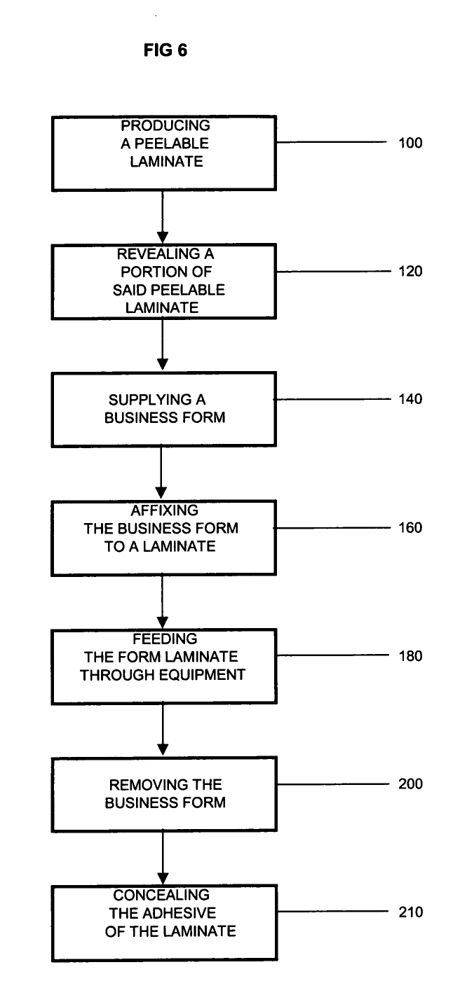

Turning now to FIG. 6, a block diagram pertaining to the method of use of the present invention is presented. Initially, at step 100 one or more laminates are provided. The laminates are constructed as described above and in a preferred embodiment would use first and second machine finished papers in which the second face, having a release surface is separably adhered to the first face of the second sheet. The sheets are disposed in substantial alignment with one another, except, in one embodiment of the present invention, one edge of the first sheet extends beyond one of the end edges of the second sheet to create an easily graspable tab to enable separation of the sheets from one another. For greater ease of understanding the method of use of the present invention, reference may also be made to FIGS. 2 through 4 and description provided herein.

After the laminates or carriers have been provided at step 100, a portion of the adhesive is revealed by grabbing and peeling back the first sheet of the laminate assembly. A light tack adhesive is generally preferred for at least the portion of the construction that is to be revealed in that it provides for easier separation of the laminate and enables reuse of the structure for processing other business forms.

Next at least one business form is supplied at step 140. In one example, the business form is a check that is attached to the exposed area of the laminate. The business form is affixed to the carrier or laminate at step 160. It should be understood that generally only that amount of the first sheet is peeled back to reveal sufficient adhesive or sufficient area of the laminate such that the entire area of the business form is contained substantially entirely within the exposed area of the laminate or in the area of the adhesive that is provided on the second sheet.

Once the business form has been affixed to the assembly at step 160, the combination of the carrier and business form are then fed through processing equipment at step 180. As suggested earlier, the processing equipment may include scanning, sorting, printing, reading, handling or processing and combinations of these. The equipment selected depends on the needs of the user processing the combination carrier and business form.

After the combination has been processed at step 180, the business form can then be removed from the laminate at step 200. The business form will generally be tack free from its exposure to the adhesive on the assembly so that it can be further processed. For example, if a SOHO were using the carrier assembly to print a check on a desktop printer, the check after printing would be removed from the carrier and delivered to the intended recipient such as through the United States Postal Service, so that the check and the payee are satisfied by the remittance.

Finally, once the business form has been removed at step 200, the carrier assembly may be readied for re-use and the first sheet is then folded back over the second sheet so that the adhesive is again concealed so as to prevent undesired contact with other papers or articles that may be present in the processing location or office area.

Through the use of repositionable adhesive, adhesive residue generally does not transfer to the business form and the adhesive can be reused when it is recovered by the top sheet.

It will thus be seen according to the present invention a highly advantageous business form intermediate for carrying documents for processing and/or handling has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form intermediate suitable for carriage or portage of documents for processing, comprising;
a laminate, said laminate having a first sheet having a front face and a back face, said first sheet having first and second transversely extending end edges and first and second longitudinally extending side edges and said first sheet having a release surface on at least a portion of said second face;
said laminate including a second sheet having a front face and a back face, said first sheet having first and second transversely extending end edges and first and second longitudinally extending side edges and said first face having a coating of adhesive applied at least a portion of said first face; and
wherein said first sheet is juxtaposed in substantial alignment with said second sheet such that said release surface is disposed over said coating of adhesive to create a peelable portion of said laminate.

2. A business form intermediate as recited in claim 1, wherein one of said first and second transversely extending end edges of said first sheet extends beyond one of said first and second transversely extending end edges of said second sheet to create a graspable tab to enable separation of said peelable portion.

3. A business form intermediate as recited in claim 1, wherein said release surface is a release coating that is applied over an entire area of said first sheet.

4. A business form intermediate as recited in claim 3, wherein said release coating is selected from a group including silicone, varnish, wax, gloss coatings and combinations thereof.

5. A business form intermediate as recited in claim 3, wherein said release coating has first and second areas.

6. A business form intermediate as recited in claim 5, wherein said first area has greater release properties than said second area.

7. A business form intermediate as recited in claim 1, wherein said release surface is provided through machine finished paper.

8. A business form intermediate as recited in claim 1, wherein said adhesive coating is a low tack adhesive.

9. A business form intermediate as recited in claim 1, wherein said first sheet is provided with at least one fold line.

10. A business form intermediate as recited in claim 1, wherein said first sheet is provided with first and second fold lines.

11. A combination business form carrier and business form, comprising;
a business form carrier, said carrier including a laminate produced from first and second sheets substantially juxtaposed on one another, said first and second sheets are held in resealable position through use of a release surface and an adhesive coating and each of said first and second sheets having an area;
a business form having a size less than each of the area of said first and second sheets of said business form carrier, said business form having first and second faces and said business form is connected to a portion of said laminate on one of said first and second faces through said adhesive; and
wherein said business form carrier with said business form contained substantially entirely within said area of one of said first and second sheets of said laminate is attached to said carrier and is processed through at least one of sorting, printing, reading, scanning equipment.

12. A combination as recited in claim 1 1, wherein said release surface is created through machine finishing at least one of said first and second sheets.

13. A combination as recited in claim 11, wherein one of said first and second sheets has a transversely extending end edge that extends in a longitudinal direction beyond another of said first and second sheets having a transversely extending end edge to create a graspable tab to enable separation of said laminate.

14. A combination as recited in claim 11, wherein said business form is selected from a group including checks, coupons, tickets, passes, certificates and combinations thereof.

15. A method of using a business form carrier, comprising the steps of;
providing a peelable laminate, said laminate including first and second sheets substantially juxtaposed on one another and at least partially adhered to one another through a release surface and adhesive coating;
revealing a portion of said laminate so as to expose an area of said adhesive coating by peeling back one of said first and second sheets such that said sheets are no longer in complete adhesive engagement with one another;
supplying at least one business form for scanning, sorting, printing, reading, handling or processing;
affixing said business form to said portion of said laminate so that said business form is substantially entirely contained on said portion; and
feeding said business form on said laminate through at least one of a scanning, sorting, printing, reading, handling or processing equipment.

16. A method as recited in claim 15, including a further step of removing said business form from said portion of said laminate after the step of feeding said business form.

17. A method as recited in claim 16, including a further step of concealing said portion of said laminate by placing said one of said first and second sheets back into adhesive engagement after the step of removing said business form.

18. A method as recited in claim 15, wherein said release surface is created by machine finishing at least one of said first and second sheets.

19. A method as recited in claim 15, wherein said business form is selected from a group including checks, coupons, tickets, passes, certificates and combinations thereof.

20. A method as recited in claim 15, wherein said business form is provided with machine readable indicia.

21. A method as recited in claim 20, wherein said machine readable indicia is selected from a group including bar codes, MICR numbering, alpha and numeric codes and patterns and combinations thereof.
